(19) United States
(12) Patent Application Publication
(10) Pub. No.: US 2004/0268335 A1
(43) Pub. Date: Dec. 30, 2004

(54) Modulo scheduling of multiple instruction chains

(75) Inventors: Allan Russell Martin, Toronto (CA); James Lawrence Mcinnes, Toronto (CA)

Correspondence Address: Diana L. Roberts, International Business Machines, Intellectual Property Law, 11400 Burnet R oad, Austin, TX, 78758, US

(73) Assignee: INTERNATIONAL BUSINESS MACHINES CORPORATON, ARMONK, NY (US)

(21) Appl. No.: 10/702,990

(22) Filed: Nov. 6, 2003

(30) Foreign Application Priority Data
Jun. 24, 2003 (CA) 2,433,379

(51) Int. Cl. G06F 9/45

(52) U.S. Cl. 717/161; 717/140

(57) ABSTRACT

Instructions of a loop are related in instruction chains represented by a data dependency graph with multiple first nodes for the instruction chains (either in a backward or forward direction). These instructions are modulo scheduled for execution by a processor. Execution parameters for each instruction denote execution relationships with previous instructions including latencies from execution of previous instructions and processor resources used by the instruction for execution. The instructions are ordered for scheduling according to a priority value for each instruction, which may be determined in a number of ways. Ordering starts with all instructions that have the highest priority value. Ordering continues with instructions related to instructions that have already been ordered; those instructions that are related and have a given priority value for the unordered instructions. After all instructions have been ordered they are modulo scheduled. Instructions are scheduled according to the previously determined order on the basis of latencies of previous related instructions, resources used by the instruction for execution and resources available in time cycles in the schedule.

### FIELD OF THE INVENTION

The present invention is related to instruction chain scheduling and more specifically to modulo scheduling of multiple instruction chains.

### BACKGROUND OF THE INVENTION

In order for a computer to execute a computer program, source code of the computer program is translated into machine readable code by a compiler. Compilers use various optimization techniques to minimize the time and computer resources used for execution of the machine readable code. One such technique, software pipelining, overlaps the execution of different iterations of a loop in the source code and executes them in parallel in an attempt to optimize utilization of the computer's resources.

Modulo scheduling, a software pipelining technique, sets a possible schedule for execution of the instructions of the machine readable code using a likely minimum number of cycles in which complete execution can occur. Instructions from a loop being scheduled are represented by a data dependency graph with each instruction being represented by a node. This graph can be analyzed to determine various characteristics such as the minimum initiation interval, i.e., the minimum number of cycles between the start of two consecutive iterations of the loop. The minimum initiation interval may form the likely minimum number of cycles.

Nodes from the data dependency graph are arranged to determine the order in which they will be placed in the schedule. Instructions from the machine readable code, each represented by a node, are placed into the possible schedule with successive instructions beyond the minimum number of cycles being scheduled to share resources with previous cycles. For example, in an eight cycle schedule instructions in cycles 0 and 8 may share the same resources and be executed simultaneously. This placement of instructions in the schedule and the wrapping around of instructions to share resources continues until all instructions are scheduled. If all instructions cannot be placed in the possible schedule, the schedule is revised and the number of cycles in the schedule is increased. Instruction scheduling is attempted again with the revised schedule. This process is repeated until all instructions of the machine readable code can be placed in the schedule or until a determined number of unsuccessful attempts to find a schedule have been made.

As the order of the nodes determines the order in which resources are assigned to each instruction (node), the order in which the nodes are scheduled can determine the performance of the scheduling. Different modulo scheduling techniques have different measures for determining node ordering. For example, Iterative Modulo Scheduling orders nodes on the basis of the node's height in the data dependency graph, Slack Modulo Scheduling orders nodes on the basis of the possible range of cycles in which a node can be scheduled, and Swing Modulo Scheduling orders nodes both from the top of the data dependency graph (forward direction) and from the bottom of the data dependency graph (backward direction) on the basis of criticality of the path and scheduling difficulty of nodes. A common technique for node ordering is to determine a single node with the highest ordering measure (e.g. height, range of cycles, etc.) to use as a starting point. From the starting point the data dependency graph may be traversed up and down ordering nodes in accordance with their relationship to the starting node.

When the data dependency graph has multiple sets of related instructions or multiple instruction chains, there may be multiple nodes that could be ordered concurrently (e.g. multiple starting points). The multiple instruction chains may be multiple independent instruction chains or multiple instruction chains with different first nodes (depending on whether the graph is considered top-down or bottom-up). If nodes are ordered only according to each successor in the graph by following a complete instruction chain, the possibility of such concurrent order is not taken into account.

### SUMMARY OF THE INVENTION

In accordance with one aspect of the present invention there is provided a method of scheduling instructions of a loop for execution by a processor, the instructions forming multiple instruction chains with different start instructions, each instruction having execution parameters, said method comprising: determining a priority value for each instruction based on a location of the instruction in each of the multiple instructions chains and the execution parameters of the other instructions; establishing an ordered list of instructions with a set of instructions having a highest priority value; expanding the ordered list with instructions related to the constituent instructions of the ordered list based on the priority values; and modulo scheduling the instructions according to the ordered list based on the execution parameters for each instruction.

In accordance with another aspect of the present invention there is provided aa system for scheduling instructions of a loop for execution by a processor, relationships between the instructions being depicted by multiple instruction chains, each instruction having execution parameters, said method comprising: a priority mechanism for determining a priority value for each instruction based on a location of the instruction in the instruction chains and the execution parameters of the other instructions; an order establish mechanism for establishing an ordered list of instructions with a set of instructions having a highest priority value; a data storage for holding the ordered list; an order expand mechanism for expanding the ordered list with instructions related to the constituent instructions of the ordered list based on the priority values; and a scheduling module for modulo scheduling the instructions according to the ordered list based on the execution parameters for each instruction.

In accordance with a further aspect of the present invention there is provided a method of forming an ordered list to order instructions in a swing modulo scheduling method comprising the steps of ordering instructions and scheduling the ordered instructions, wherein the instructions form multiple instruction chains with different start instructions, each instruction having execution parameters, the method comprising: determining a priority value for each instruction based on a location of the instruction in each of the multiple instructions chains and the execution parameters of the other instructions; establishing an ordered list of instructions with a set of instructions having a highest priority value; and expanding the ordered list with instructions related to the constituent instructions of the ordered list based on the priority values.

In accordance with yet another aspect of the present invention there is provided a computer-readable medium having computer-executable instructions for forming an ordered list to order instructions in a swing modulo scheduling method comprising the steps of ordering instructions and scheduling the ordered instructions, wherein the instructions form multiple instruction chains with different start instructions, each instruction having execution parameters, said computer-executable instructions comprising: determining a priority value for each instruction based on a location of the instruction in each of the multiple instructions chains and the execution parameters of the other instructions; establishing an ordered list of instructions with a set of instructions having a highest priority value; and expanding the ordered list with instructions related to the constituent instructions of the ordered list based on the priority values.

Instructions of a loop are related in instruction chains represented by a data dependency graph with multiple first nodes for the instruction chains (either in a backward or forward direction). These instructions are modulo scheduled for execution by a processor. Execution parameters for each instruction denote execution relationships with previous instructions including latencies from execution of previous instructions and processor resources used by the instruction for execution. The instructions are ordered for scheduling according to a priority value for each instruction, which may be determined in a number of ways. Ordering starts with all instructions that have the highest priority value. Ordering continues with instructions related to instructions that have already been ordered; those instructions that are related and have a given priority value for the unordered instructions. After all instructions have been ordered they are modulo scheduled. Instructions are scheduled according to the previously determined order on the basis of latencies of previous related instructions, resources used by the instruction for execution and resources available in time cycles in the schedule.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The present invention will be described in conjunction with the drawings in which:

FIG. 1 is a system diagram of an exemplary computing environment suitable for implementation of the present invention;

FIGS. 2A and B are flow diagrams for modulo scheduling of multiple instruction chains in accordance with an embodiment of the present invention;

FIG. 3 is a flow diagram for a modulo scheduling method in accordance with another embodiment of the present invention;

FIG. 4 is a system diagram of a modulo scheduling system in accordance with an embodiment of the present invention;

FIG. 5 is a system diagram of a modulo scheduling system in accordance with another embodiment of the present invention; and

FIG. 6 is an exemplary data dependency graph for use with the present invention.

### DETAILED DESCRIPTION OF EMBODIMENTS OF THE PRESENT INVENTION

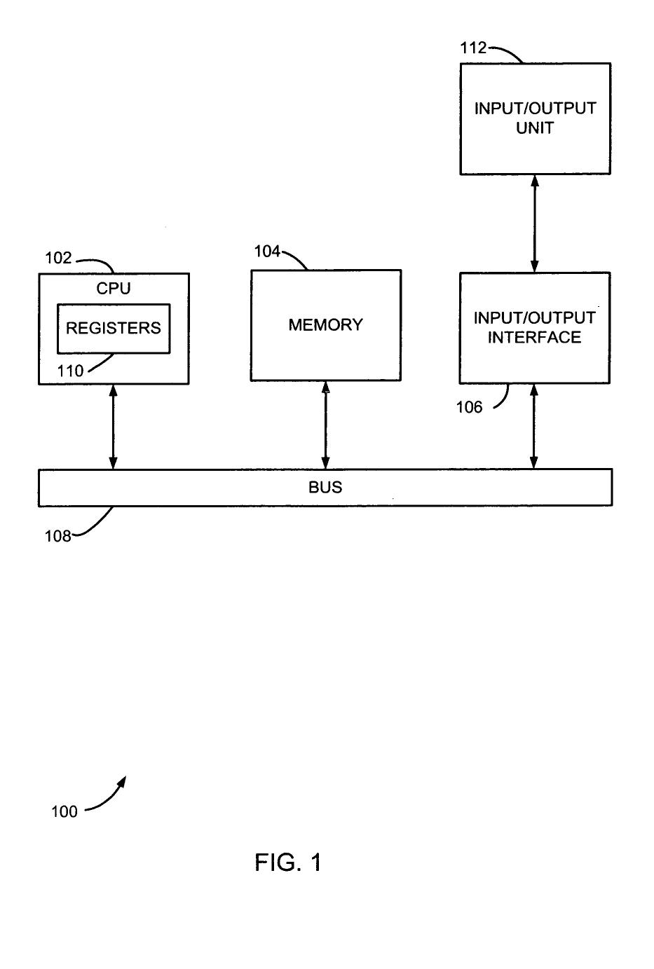

FIG. 1 illustrates a configuration of a computer 100 in which the present invention may be implemented.

The computer 100 includes a central processing unit (CPU) 102, a memory 104, an input/output interface 106 and a bus 108. The CPU 102, the memory 104 and the input/output interface 106 are connected with one another via the bus 108. The input/output interface 106 is configured so that it can be connected to an input/output unit 12.

The present invention may be embodied in a program stored in, for example, the memory 104. Alternatively, the present invention may be recorded on any type of recording medium such as a magnetic disk or an optical disk. The present invention recorded on such a recording medium is loaded to the memory 106 of the computer 100 via the input/output unit 12 (e.g. a disk drive).

The CPU 102 can be a commercially available CPU or a customized CPU suitable for operations described herein. Other variations of CPU 102 can include a plurality of CPUs interconnected to coordinate various operations and functions. The CPU 102 contains resources for the execution of the present invention including registers 110 that enable basic functions such as placing a value into a specified register (referred to as a “load” operation), copying a value stored in a specified register to a specified memory location (referred to as a “store” operation), and performing arithmetic operations, such as addition and multiplication, on values stored in memory locations and registers. The computer 100 serves as an apparatus for performing the present method by the CPU 102 executing the present invention.

Modulo scheduling of a computer program involves the re-ordering of hardware instructions, obtained from a translation of source code, specifically to minimize the execution time of a loop. Each loop may be composed of related or unrelated instructions. Related instructions rely on the outcome of previous instructions (predecessors) or are relied upon for subsequent instructions (successors). Groups of related instructions may form chains of related instructions, termed instruction chains. A loop may contain one or multiple instruction chains. These instruction chains may be independent of one another, or have different start or end nodes (depending on the direction from which the graph is assessed). Execution of the hardware instructions is scheduled to take into account the resources (e.g. registers) available for such execution as well as the time delays or latencies between successive related instructions.

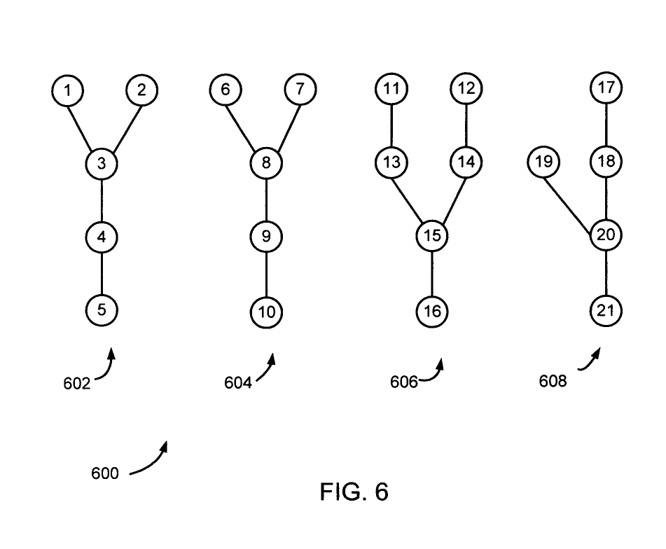

FIG. 6 illustrating an exemplary data dependency graph 600 having multiple instruction chains 602, 604, 606, 608. Instruction chains 602, 604, 606, 608 are independent of each other while may be composed of multiple connected instruction chains. Instruction chains 602, 604, 606 have multiple start nodes from the forward direction (i.e. nodes 1, 2, 5, 6, 9, 10). In the exemplary data dependency graph 600, node 3 has predecessor nodes 1 and 2 and successor node 4.

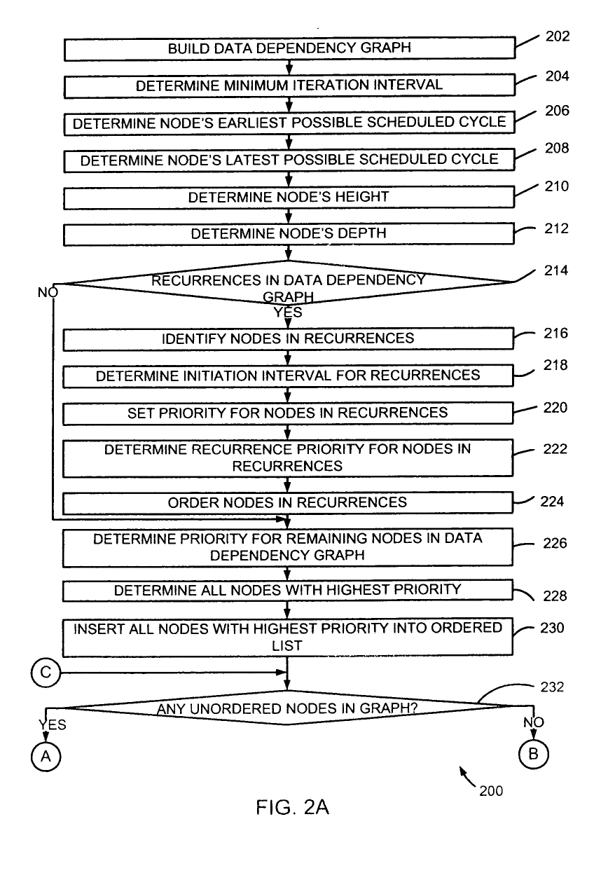

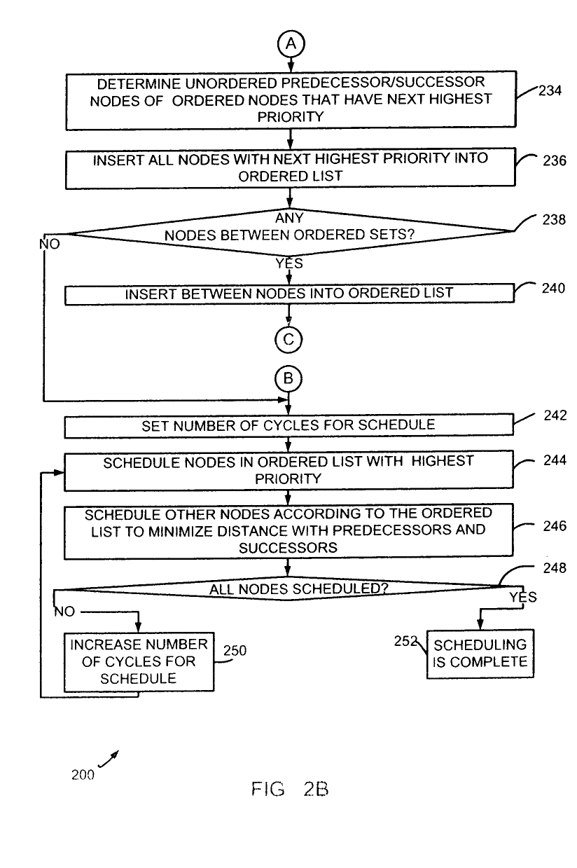

FIGS. 2A and B is a flow diagram of a modulo scheduling method 200 for multiple instruction chains. The modulo scheduling method 200 orders multiple instruction chains concurrently according to a priority prior to placing them in a schedule. That is, the modulo scheduling method 200 orders the starting nodes of each instruction chain concurrently according to the priority of each starting node. The modulo scheduling method 200 is primarily based on Swing Modulo Scheduling although various segments of the method 200 may be implemented in conjunction with other modulo scheduling methods.

A data dependency graph (such as the one illustrated in FIG. 6) is built in step 202 by any of a number of techniques known in the art. The data dependency graph represents each hardware instruction from the loop being scheduled as a node in the graph. The nodes in the graph are connected by edges representing the data flow and displaying the relationship between instructions and iterations. The instructions on which the current instruction depends are represented as the predecessors of the current node in the graph. The instructions that depend on the current instruction are represented as the successors of the current node in the graph. The data dependency graph may represent data from different iterations of the loop. For example, an instruction may use a value of a variable from a previous iteration of another instruction from the loop. Each edge is described, by the latency during execution of the instruction from the first node connected to the edge (predecessor) and the number of iterations between the dependency of the two nodes connected by the edge.

The data dependency graph is analyzed in steps 204 to 212 obtain various relative characteristics for nodes in the graph.

The minimum initiation interval for the loop represented by the data dependency graph is determined in step 204. The minimum initiation interval is the minimum number of cycles that could be used to complete one iteration of the loop, or between the initiation of two consecutive iterations.

The earliest possible cycle in which the instruction from each node could be scheduled is determined in step 206. The earliest possible cycle for a node is based on the possible scheduled cycles of the predecessors of the node as well as the latencies of the predecessor instructions. If a node has no predecessors then the earliest possible cycle in which it could be scheduled is the first cycle (cycle 0). If a node u has a predecessor node v then the earliest possible cycle may be determined by:

$${ASAP}_{u} = max ( {ASAP}_{v} + {λ}_{v} + {δ}_{u , v} * MII ) ∀ v ∈ pred ( u )$$

where ASAPᵤ is the earliest possible cycle in which the node u can be scheduled, ASAPᵥ, is the earliest possible cycle in which the node v can be scheduled, λᵥ is the latency or number of cycles that instruction of node v takes to complete, δ_{u,v} represents the number of iterations between of node u and node v, MII is the minimum initiation interval for the data dependency graph, and pred(u) is the set of predecessor nodes for the node u.

The latest possible cycle in which the instruction from each node could be scheduled is determined in step 208. The latest possible cycle is based on the possible scheduled cycles of the successors of each node as well as the latency of the instruction of the current node. If a node has no successors then the latest possible cycle in which it could be scheduled is the latest of the earliest scheduled cycles for all nodes in the graph. If a node u has a successor v then the latest possible cycle may be determined by:

$${ALAP}_{u} = min ( {ALAP}_{v} + {λ}_{u} + {δ}_{u , v} * MII ) ∀ v ∈ suc ( u )$$

where ALAPᵤ is the latest possible cycle in which the node u can be scheduled, ALAPᵥ is the latest possible cycle in which the node v can be scheduled, λᵤ is the latency or number of cycles that the instruction of node u takes to complete, δ_{u,v} represents the number of iterations between node u and node v, MII is the minimum initiation interval for the dependency graph, and suc (u) is the set of successor nodes for the node u.

The height of each node is determined in step 210 by the maximum number of successors for each node weighted by the latency of the instruction for each successor. If the node has no successors then the height of the node is 0. The height is a measure of the number of cycles the node is from the bottom of the graph.

The depth of each node is determined in step 212 by the maximum number of predecessors for each node weighted by the latency of the instruction for each predecessor. If the node has no predecessors then the depth of the node is 0. The depth is a measure of the number of cycles the node is from the top of the graph.

The nodes in the data dependency graph are ordered in steps 214 to 240 to form an ordered list. This order may be based on various characteristics of the nodes that determine its priority (e.g. the time(s) in which the node could be scheduled based on predecessors and successors). Recurrences in the data dependency graph are considered separately in steps 214 to 224 and then in the context of the entire graph in steps 226 to 246.

While a graph with no recurrences allows for a straight flow of data from the top of the graph to the bottom of the graph, a data dependency graph with recurrences has both downward and upward flow of data. Such recurrences in the data dependency graph are identified in step 214. If the data dependency graph includes recurrences all nodes in each recurrence are identified in step 216. The nodes in each recurrence are grouped together as a set that is treated as a single node in the context of the overall data dependency graph. If there are no recurrences then the method 200 proceeds to step 226.

After the nodes in each recurrence have been identified, the initiation interval for each recurrence is determined in step 218. The initiation interval for each recurrence is used to prioritize the recurrences relative to each other. The recurrence(s) with the highest initiation interval receives the highest priority among the recurrences as the nodes in this recurrence may be the most difficult to place in a schedule. The priority for each recurrence is determined in descending order of the value of the initiation interval with recurrences with high initiation intervals receiving the high priorities. The nodes in a recurrence form a set with each node in the set assigned the same priority. That is, the priority for each node in a recurrence is set according to the priority of the recurrence in step 220.

After the nodes in the recurrences have been identified and a general priority for each recurrence has been set, a recurrence priority for each node within each recurrence is determined in step 222. The recurrence priority for each node is determined by treating the recurrence as a separate data dependency graph and prioritizing each node in the separate data dependency graph.

Priority for nodes can be determined according to various criteria. Nodes can be assigned both a forward and a backward priority, placing emphasis on predecessors or successors, respectively. The priority of each node is a numerical indication of the criticality of the node for execution purposes (e.g. the node may have many successors that require the node to be completed). For example, priority may be determined as follows:

Forward Priority=(Initiation Interval)−(Earliest Cycle for Scheduling Node)

Backward Priority=(Latest Cycle for Scheduling Node)

The priority for each node may be any representation that provides an order to the nodes such that both the predecessors and successors of a node are not ordered before the node itself.

Each node in the recurrence is ordered within the set according to the priority for the node in step 224. This produces a set for which each node in the set has equal priority within the context of the overall data dependency graph but with each node being ordered within the set according to its recurrence priority.

After the recurrences in the data dependency graph have been identified, or if there were no recurrences in the data dependency graph as determined in step 214, the priority for all remaining nodes (not part of a recurrence) is determined in step 226. The forward and backward priority for these nodes may be determined in a manner similar to the recurrence priority determination.

All nodes have now been given a priority, with nodes from the recurrences being treated as a single node. The nodes with the highest priority are determined in step 228. The priority for the first set of nodes in the ordered list may be based on the previously mentioned priority, the smallest difference between the earliest and latest possible scheduled cycles (i.e. slack) or the largest number of predecessors or successors. All nodes with the highest priority are inserted in the ordered list in step 230. If the node(s) with the highest priority includes nodes from a recurrence then the recurrence nodes are placed in the ordered list according to the order in the recurrence set as determined by the node's recurrence priority. The set of all nodes with the highest priority is placed at the beginning of the ordered list, thus establishing the list. As these nodes have the same priority their placement in the list relative to each other may be random, although the relative order of nodes from a recurrence is maintained. Thus, all start nodes for a graph are ordered simultaneously. As new nodes are placed in the ordered list, the nodes already in the order are compared with the new nodes so that any duplication between the new nodes and the nodes already in the ordered list can be removed.

Step 232 determines if there are any nodes in the graph that have not been ordered in the ordered list. If there are no unordered nodes then the method 200 continues with step 242. If there are unordered noes, the nodes having the next highest priority or some given priority (e.g. not lower than a predetermined value) are determined in step 234. To try to maintain a somewhat sequential ordering, only those nodes whose predecessor nodes (or successor nodes, depending on the direction of the graph being considered) have been ordered are considered. The priority of these nodes is used to determine the next set of nodes to be inserted into the ordered list. All nodes that are related to nodes currently in the ordered list and have the next highest priority or some given priority are inserted into the list in step 236. Since all nodes having the highest priority are inserted into the ordered list in step 230 simultaneously, the instruction chains following from each of these nodes may be inserted into ordered list concurrently. Each node that depends from the nodes inserted in step 230 may be simultaneously inserted in step 236. That is, the nodes that can be inserted in step 236 are not limited as would be the case if only one node was inserted in step 230. Thus, all nodes of equal priority may be inserted in step 236 instead of nodes of lower priority being inserted in the ordered list ahead of nodes of higher priority because of limitations due to the initially inserted nodes.

Next, step 238 determines if there are any nodes between ordered nodes that have not themselves been ordered. If there are no nodes between nodes then the method continues to step 242. If there are any nodes between ordered nodes they are inserted into the ordered list in step 240. These in-between-nodes are placed in the ordered list after the latest node. Although these nodes may be ordered before nodes with a higher priority, this occurs since both the predecessors and successors of these nodes are already in the ordered list. Considering the in-between nodes out of priority sequence takes into account the situation where the node's predecessors and successors are scheduled before the node itself is scheduled. These in-between nodes may be nodes that occur between recurrences, for example. The in-between nodes are placed in the ordered list according to their priority as determined in step 226. After the in-between nodes have been ordered, or if there were no in-between-nodes, it is again determined if there are any nodes in the graph that have not been ordered, step 232. If there are still nodes that have not been ordered, steps 232 to 240 are repeated until all nodes have been ordered.

After the nodes have been ordered they are scheduled in steps 242 to 252 An outline of the schedule is determined in step 242 by setting a likely minimum number of cycles into which the instructions are to be scheduled. This creates a table into which instructions can be placed for scheduling. The minimum number of cycles may be the minimum initiation interval for the data dependency graph.

The node with the highest priority according to the ordered list is placed in the schedule first in step 244, generally in the first cycle. Each subsequent node is placed in the schedule according to their position in the ordered list in step 246. The placement of each node into the schedule is based upon the availability of resources used by the instruction of the node for execution. The goal for the placing each node into the schedule is to minimize the distance between the node's predecessors and successors while taking into account latencies between the completion of the instructions from the predecessors and the current node. If it is determined in step 248 that all nodes in the data dependency graph can be placed in the schedule then scheduling is deemed to be completed in step 252. If not all nodes can be placed in the schedule then the number of cycles in the schedule is increased in step 250 and steps 244 to 248 are repeated until an acceptable schedule can be found, or a predetermined time or number of unsuccessful attempts expires.

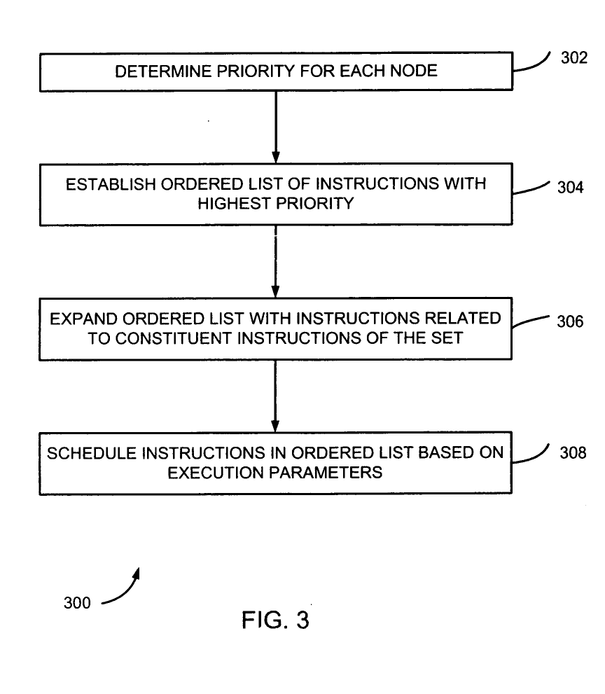

FIG. 3 is a flow chart of a method 300 of scheduling instructions of a loop according to the present invention. As with the method shown in FIGS. 2A and B, the method 300 orders multiple instruction chains concurrently according to a priority prior to placing them in a schedule. The priority of each instruction is determined in step 302. The priority may be determined in a manner similar to that described in conjunction with FIGS. 2A and B.

An ordered list for the instructions is established in step 304. This ordered list performs the same function as the ordered list in FIGS. 2A and B, i.e., provides an order in which the instructions are scheduled. The ordered list is established with the set of instructions that have the highest priority. That is, all instructions with the highest priority are placed in the ordered list. The list is expanded in step 306 with instructions related to those already in the list on the basis of the priority of these unordered instructions. That is, the list is expanded in a step-wise manner with instructions that are related to those already in the list (predecessors or successors depending on the direction of interest) based on the priority of these predecessor or successor instructions (i.e. unordered instructions with high priority are inserted into the list).

After the list is completed, the instructions are modulo scheduled in step 308 according to the ordered list and on the basis of execution parameters for the instructions. These execution parameters include latencies of the instruction and the instruction's predecessors (or successors) as well as the resource(s) used by the instruction for execution and the resources available for use by the instruction, taking into consideration the resources available in the environment of execution and also the resources available at a given time.

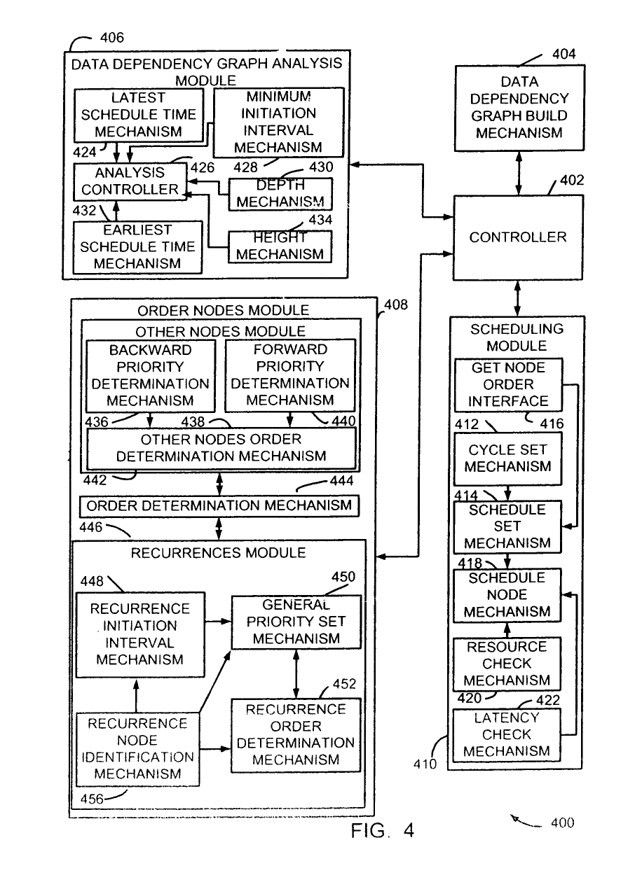

FIG. 4 shows a modulo scheduling system 400 according to an embodiment of the present invention. The functions of the modulo scheduling system 400 are defined by various modules and mechanisms discussed in detail below. Each module contains mechanisms that implement various functions for managing processes that are used during ordering and scheduling tasks, for example. The modulo scheduling system 400 re-orders and schedules hardware instructions of a loop. The hardware instructions are obtained by a controller 402 that manages the scheduling of the instructions for execution. The controller 402 coordinates the process of building a data dependency graph from the hardware instructions, ordering the various instructions and scheduling the instructions for execution according to their order.

A data dependency graph build mechanism 404 receives the hardware instructions from the controller 402 and builds a data dependency graph therefrom. The data dependency graph may be constructed using any of a number of well known algorithms. After creation, the data dependency graph is provided to the controller 402.

A data dependency graph analysis module 406 receives the data dependency graph from the controller 402 for analysis purposes. The data dependency graph is analyzed to determine various properties of the graph. These properties may include the minimum initiation interval, the height and depth of each node in the graph as well as the earliest and latest cycle in which each node can be scheduled. The properties are provided to the controller 402.

The data dependency graph analysis module 406 has an analysis controller 426 for coordinating the analysis of the data dependency graph. The analysis controller 426 interfaces with a minimum initiation interval mechanism 428, a latest schedule time mechanism 424, an earliest schedule time mechanism 432, a depth mechanism 430 and a height mechanism 434 for determination of various properties of the data dependency graph. The minimum initiation interval mechanism 428 determines the minimum initiation interval for the data dependency graph. The depth mechanism 430 determines the depth of each node in the data dependency graph. The height mechanism 434 determines the height of each node in the data dependency graph. The earliest schedule time mechanism 432 determines the earliest cycle in which a node can be scheduled. The latest schedule time mechanism 424 determines the latest cycle in which a node can be scheduled.

An order nodes module 408 receives the data dependency graph and the properties derived from the data dependency graph. The order nodes module 408 determines a ordered list in which each of the nodes in the data dependency graph will be scheduled. The ordered list is provided to the controller 402 upon completion.

The order nodes module 408 has an order determination mechanism 444 for coordinating the ordering of the nodes in the data dependency graph. The order determination mechanism 444 interfaces with an other nodes module 442 and a recurrences module 446 for ordering the nodes.

The order determination mechanism 444 assesses the data dependency graph to determine if there are recurrences in the graph. If the graph contains recurrences it is provided to the recurrences module 446 where a recurrence node identification mechanism 456, a recurrences priority determination mechanism 454, a recurrences initiation interval mechanism 448 and a general priority set mechanism 450 determine recurrences in the graph and their priority.

The recurrence node identification mechanism 456 is provided with the data dependency graph so that each recurrence in the graph and all nodes in each recurrence can be identified. The nodes in each recurrence form a set that is treated as a single node by the order determination mechanism 444. The set of nodes in each recurrence are provided to the recurrences priority determination mechanism 454, the recurrences initiation interval mechanism 448 and the general priority set mechanism 450.

The recurrence initiation interval mechanism 448 receives a set of nodes representing a recurrence and determines the initiation interval of the recurrence. The initiation interval is provided to the general priority set mechanism 450.

The initiation interval is used to determine the priority for each set of nodes from a recurrence, with the highest initiation interval garnering the highest priority. The general priority set mechanism 450 sets the priority for each node in the set to be the same as the entire priority of the set (i.e. all nodes in the set representing a recurrence have the same priority).

The recurrences priority determination mechanism 454 orders the nodes within each set. Each set is considered to be a separate data dependency graph. Within this context a recurrence priority for each node in the graph is determined in a manner similar to the priority for nodes in the larger data dependency graph. The nodes within the set are then ordered according to the priority. This ordering is used when the nodes are placed in the ordered list.

The order determination mechanism 444 also passes the data dependency graph to the other nodes mechanism 442. An other nodes order determination mechanism 438 coordinates ordering all other nodes in the graph according to priorities determined by a backward priority determination mechanism 436 and a forward priority determination mechanism 440.

The backward priority determination mechanism 436 determines the backward priority of all nodes in the graph at the prompting of the other nodes order determination mechanism 438. The forward priority determination mechanism 440 determines the forward priority of all nodes in the graph at the prompting of the other nodes order determination mechanism 438. The other nodes order determination mechanism 438 provides these priority values to the order determination mechanism 442.

The ordered sets and the relative order are provided to the order determination mechanism 444. The order determination mechanism 444 orders the recurrence nodes and the other nodes according to priority. All nodes with the highest priority are inserted in to the ordering list. Each node from a recurrence is inserted into the ordered list according to the ordering within the set. Subsequently, instruction chains may be traversed by the order determination mechanism 444 to insert all nodes depending from those already in the ordered list

A scheduling mechanism 410 receives the ordered list from the controller 402 and determines a cycle in which each instruction represented by a node in the graph will be performed. The ordered list is received at a get node order interface 416 of the scheduling mechanism 410.

A cycle set mechanism 412 determines the likely minimum number of cycles in which the loop represented by the data dependency graph may be executed.

The number of cycles for the schedule is provided to the schedule set mechanism 414 where the schedule is created. The schedule produced by the schedule set mechanism 414 is an empty schedule as no instructions have been placed in the schedule.

The schedule is provided to a schedule node mechanism 418 where the instructions are placed in the schedule. The schedule node mechanism 418 is also provided with the ordered list by the get node interface 416. The scheduling node mechanism 418 coordinates the placement of each node into the schedule, balancing various criteria and constraints. The schedule node mechanism 418 consults a resource check mechanism 420 and a latency check mechanism 422 to assess if instructions from a node can be placed in a particular cycle in the schedule (i.e. meets criteria and constraints).

The schedule node mechanism 418 considers each node in the order provided in the ordered list. If the node being placed in the schedule does not have any predecessors then the schedule node mechanism 418 starts at the beginning of the schedule and tries to place the node into the first available cycle in the schedule according to available resources. If the node being placed in the schedule has predecessors then the schedule node mechanism 418 starts trying to place the node in the schedule according to available resources at the cycle that is advanced by the predecessor's latency from the scheduled cycle of the predecessor.

The resource check mechanism 420 determines if there are sufficient resources to perform the instruction of a node in a given cycle in the schedule. The resource check mechanism 420 assesses the other instructions that are to be performed in the given cycle to determine if the resources used by the instruction being placed are available.

The latency check mechanism 422 determines the earliest cycle in which the instruction of a node can be scheduled given the scheduling of the node's predecessors and the latency of those predecessors. That is, the node can only be scheduled after the instructions from the predecessors have completely executed. For example, if a node u has a predecessor node v that takes 2 cycles to complete and is scheduled in cycle 0 then node u cannot be scheduled before cycle 2 due to the latency of node v.

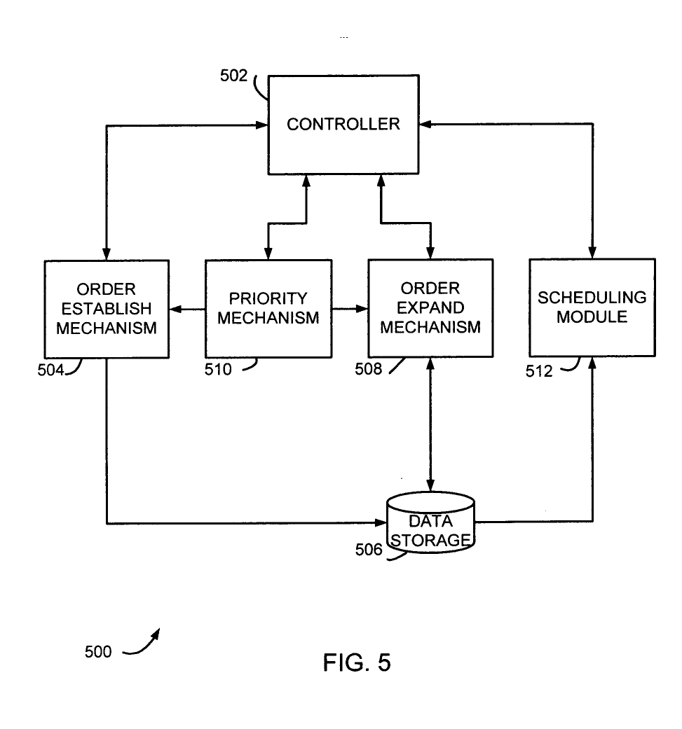

FIG. 5 shows a system 500 for scheduling instructions of a loop. The functions of the system 500 are defined by various modules and mechanisms that implement various functions for managing processes that are used during ordering and scheduling tasks, for example. As with FIG. 4, the system 500 re-orders and schedules hardware instruction of a loop. The hardware instructions are obtained by a controller 502 that manages the scheduling of the instructions for execution. The controller 502 coordinates the process of ordering the instructions and scheduling the instructions for execution according to their order.

A priority mechanism 506 receives the instructions from the controller 502 and determines the priority for each instruction. The priority may be determined in a manner similar to that described in conjunction with FIG. 4. These priority values may be stored in a data storage 506.

An order establish mechanism 504 receives the instructions from the controller 502 and the priority values from the priority mechanism 506. The order establish mechanism 504 determines the set of instructions that have the highest priority. That is, all instructions with the highest priority are determined. An ordered list is established using the set of instructions with the highest priority as the first members of the list. This ordered list performs the same function as the ordered list in FIG. 4, it provides an order in which the instructions are scheduled. All instructions with the highest priority value are present in the ordered list. The list is stored in the data storage 506

An order expand mechanism 508 receives the priority values from the priority mechanism 510 and is informed by the controller 502 that the ordered list has been created and needs to be expanded. The order expand mechanism 508 adds instructions related to those instructions already in the list that have the highest priority of all instructions not yet ordered. That is, the order expand mechanism 508 expands the list with instructions that are related to those already in the list (predecessors or successors depending on the direction of interest) based on the priority of these predecessor or successor instructions (i.e. instructions highest priority are inserted into the list). After each addition the order expand mechanism 508 updates the list stored in the data storage 506 with the newest members.

A scheduling module 512, containing functions for creating a schedule for the instructions, is informed by the controller 502 that the ordered list has been completed. The scheduling module 512 obtains the ordered list from the data storage 506. The instructions are modulo scheduled by the scheduling module 512 according to the ordered list on the basis of execution parameters for the instructions. These execution parameters include latencies of the instructions and the instruction's predecessors (or successors) as well as the resource(s) used by the instruction and the resources available for use by the instruction taking into consideration the resources available in the environment of execution and also the available resources at a given time.

A data storage 506 holds the ordered list and provides the list to all mechanisms and modules of the system 500. The data storage 506 may also hold the priority value for each instruction.

As described above, FIG. 6 shows an exemplary data dependency graph 600 with four independent instruction chains 602, 604, 606, 608. The minimum initiation interval for this graph is 6. None of the instruction chains 602, 604, 606 and 608 have a recurrence. Instruction chains 602, 604 and 606 have multiple start nodes.

TABLE 1
Properties for Nodes Shown In Data Dependency Graph in FIG. 6

| Node | Height | Depth | Earliest | Forward Priority | Backward Priority |
|---|---|---|---|---|---|
| 1 | 12 | 0 | 0 | 4 | 1 |
| 2 | 12 | 0 | 0 | 4 | 1 |
| 3 | 8 | 4 | 4 | 3 | 2 |
| 4 | 4 | 8 | 8 | 2 | 3 |
| 5 | 0 | 12 | 12 | 1 | 4 |
| 6 | 12 | 0 | 0 | 4 | 1 |
| 7 | 12 | 0 | 0 | 4 | 1 |
| 8 | 8 | 4 | 4 | 3 | 2 |
| 9 | 4 | 8 | 8 | 2 | 3 |
| 10 | 0 | 12 | 12 | 1 | 4 |
| 11 | 12 | 0 | 0 | 4 | 1 |
| 12 | 12 | 0 | 0 | 4 | 1 |
| 13 | 8 | 4 | 4 | 3 | 2 |
| 14 | 8 | 4 | 4 | 3 | 2 |
| 15 | 4 | 8 | 8 | 2 | 3 |
| 16 | 0 | 12 | 12 | 1 | 4 |
| 17 | 12 | 0 | 0 | 4 | 1 |
| 18 | 8 | 4 | 4 | 3 | 2 |
| 19 | 8 | 0 | 0 | 3 | 1 |
| 20 | 4 | 8 | 8 | 2 | 3 |
| 21 | 0 | 12 | 12 | 1 | 4 |

Table 1 shows the values for various properties for nodes 1-21 if each node has a latency of 4.

According to the present invention the set of all other nodes with the highest priority is determined. This forms the set {1,2,6,7, 11, 12,17} which are all start nodes for the various instruction chains 602, 604, 606 and 608. This set becomes the basis of the ordered list.

Those nodes depending from the nodes in the ordered list that have the next highest priority are determined. This forms the set {3,8,13,14,18}. These nodes are inserted into the ordered list to form {1,2,6,7,11,12,17,3,8,13,14,18}. As this process continues the final ordered list is {1,2,6,7,11,12,17,3,8,13,14,18,4,9,15,20,5,10,16,21,19}.

Scheduling may then be performed on the basis of the ordered list. Consider the example where nodes 1,2,6,7,11,12,17,5,10,16,21, and 19 are all load/store operations and nodes 3,8,13,14,18,4,9,15 and 20 are all arithmetic operations. If each instruction has a latency of 4 and there are 2 load/store units available and 2 arithmetic units available, then the resulting schedule is shown in Table 2 where L represents a load/store unit and A represents an arithmetic unit.

TABLE 2
Modulo Scheduling of Nodes from Table 1

| Cycle | L | L | A | A |
|---|---|---|---|---|
| 0 | 1 | 2 | | |
| 1 | 6 | 7 | | |
| 2 | 11 | 12 | | |
| 3 | 17 | 19 | | |
| 4 | | | 3 | |
| 5 | | | 8 | |
| 6 | | | 13 | 14 |
| 7 | | | 18 | |
| 8 | | | 4 | |
| 9 | | | 9 | |
| 10 | | | 15 | |
| 11 | | | 20 | |
| 12 | 5 | | | |
| 13 | 10 | | | |
| 14 | 16 | | | |
| 15 | 21 | | | |

If the above example were modified to include four instruction chains having four nodes each with a configuration similar to nodes 1, 2, 3 and 4 in FIG. 6 (16 nodes in the complete graph), there would be eight start nodes {nodes 1, 2, 5, 6, 9, 10, 13, 14}, four middle nodes {3, 7, 11, 15}and four end nodes {4, 8, 12, 16}. Since there are eight start nodes in this configuration, the order produced by the present invention is {1,2,5,6,9,10,13,14,3,7,11,15,4,8,12,16}. Another algorithm, such as swing modulo scheduling, might produce the following order {1,2,3,4,5,6,7,8,9,10,11,12,13,14,15,16}. Consider the case where the eight start nodes and four end nodes are load/store instructions and the four middle nodes are algorithmic instructions. If there are two load/store units for the load/store instructions and one algorithmic unit for the algorithmic instructions and each instruction has a delay of four cycles then the schedule in Table 3 is produced using the ordering of the present invention whereas it is not possible to schedule the other order in the same (or fewer) cycles.

TABLE 3
Modulo Scheduling of Nodes from Modified Example

| Cycle | L | L | A |
|---|---|---|---|
| 0 | 1 | 2 | |
| 1 | 5 | 6 | |
| 2 | 9 | 10 | |
| 3 | 13 | 14 | |
| 4 | | | 3 |
| 5 | | | 7 |
| 6 | | | 11 |
| 7 | | | 15 |
| 8 | | | |
| 9 | | | |
| 10 | 4 | 8 | |
| 11 | 12 | 16 | |

The present invention seeks all nodes having the highest priority thus enabling multiple nodes to be inserted into the ordered list at the same time. Traditionally, the ordering of nodes would be performed from a single starting point (e.g. node 1) and the instruction chain would be traversed to follow all successors of the node. The instruction chain would be traversed forward and backward until all nodes were ordered and then the next instruction chain would be traversed.

The present invention may be embodied as an extension of the Swing Modulo Scheduling algorithm. Swing modulo scheduling includes the basic steps of developing a data dependency graph from the instructions that are being scheduled; ordering the nodes in the data dependency graph, thereby ordering the instructions; and modulo scheduling the instructions according to the placement of their corresponding node in the order. The present invention may be embodied as a revision of the ordering step by ordering multiple nodes initially.

Embodiments of the present invention may be implemented in any conventional computer programming language. Further embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g. a diskette, CD-ROM, ROM, or fixed disk) or transmittable to a computer system, via a modem or other interface device, such as a communications adapter connected to a network over a medium. The medium may be either a tangible medium (e.g. optical or electrical communications lines) or a medium implemented with wireless techniques (e.g. microwave, infrared or other transmission techniques). The series of computer instructions embodies all or part of the finctionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g. shrink wrapped software), preloaded with a computer system (e.g., on system ROM or fixed disk), or distributed from a server over the network (e.g., the Internet or World Wide Web). Some embodiments of the invention may be implemented as a combination of both software (e.g. a computer program product) and hardware (termed mechanisms). Still other embodiments of the invention may be implemented as entirely hardware, or entirely software (e.g. a computer program product).

It is apparent to one skilled in the art that numerous modifications and departures from the specific embodiments described herein may be made without departing from the spirit and scope of the invention.

1. A method of scheduling instructions of a loop for execution by a processor, the instructions forming multiple instruction chains with different start instructions, each instruction having execution parameters, said method comprising:
(a) determining a priority value for each instruction based on a location of the instruction in each of the multiple instructions chains and the execution parameters of the other instructions;
(b) establishing an ordered list of instructions with a set of instructions having a highest priority value;
(c) expanding the ordered list with instructions related to the constituent instructions of the ordered list based on the priority values; and
(d) modulo scheduling the instructions according to the ordered list based on the execution parameters for each instruction.

2. The method according to claim 1 wherein step (b) includes:
identifying instructions with the highest priority value to form the set of instructions;
and inserting each instruction in the set of instructions into the ordered list.

3. The method according to claim 1 wherein the set of instructions includes the start instructions.

4. The method according to claim 1 wherein step (c) includes:
determining all instructions depending from instructions in the ordered list; and
inserting instructions depending from instructions in the ordered list having a given priority value into the ordered list.

5. The method according to claim 1 wherein step (a) includes:
determining a latency of all successive instructions from the execution parameters of the other instructions to form the priority value for each instruction.

6. The method according to claim 1 wherein step (a) includes:
identifying instructions in a recurrence to form a recurrence set;
determining a priority value for the recurrence;
assigning the priority value for the recurrence to the identified instructions and
ordering the instructions in the recurrence set on the basis of a priority of each instruction in the recurrence set;
wherein the recurrence set is treated as a single instruction in steps (a) to (c).

7. The method according to claim 1 wherein step (d) includes:
establishing an outline schedule with a determined number of execution cycles, wherein cycles in the outline schedule subsequent to the determined number are in parallel with the determined number of execution cycles;
developing an execution schedule by placing instructions in the outline schedule according to the ordered list and the execution parameters for each instruction; and
revising the determined number of execution cycles in the outline schedule according to the developed execution schedule in order to place all instructions in the outline schedule.

8. A system for scheduling instructions of a loop for execution by a processor, relationships between the instructions being depicted by multiple instruction chains, each instruction having execution parameters, said method comprising:
a priority mechanism for determining a priority value for each instruction based on a location of the instruction in the instruction chains and the execution parameters of the other instructions;
an order establish mechanism for establishing an ordered list of instructions with a set of instructions having a highest priority value;
a data storage for holding the ordered list;
an order expand mechanism for expanding the ordered list with instructions related to the constituent instructions of the ordered list based on the priority values; and
scheduling module for modulo scheduling the instructions according to the ordered list based on the execution parameters for each instruction.

9. The system according to claim 8 wherein the order establish mechanism includes:
a list mechanism for identifying instructions with the highest priority value to form the set of instructions and inserting each instruction in the set of instructions into the ordered list.

10. The system according to claim 8 wherein the order expand mechanism includes:
a depending instruction mechanism for determining all instructions depending from instructions in the ordered list and inserting instructions depending from instructions in the ordered list having the a given priority value into the ordered list.

11. The system according to claim 8 wherein further including:
a recurrence identification mechanism for identifying instructions in a recurrence to form a recurrence set;
a recurrence priority determination mechanism for determining a priority value for the recurrence;
a priority set mechanism for assigning the priority value for the recurrence to the identified instructions; and
a recurrence order mechanism for ordering the instructions in the recurrence set on the basis of a priority of each instruction in the recurrence set.

12. A method of forming an ordered list to order instructions in a swing modulo scheduling method comprising the steps of ordering instructions and scheduling the ordered instructions, wherein the instructions form multiple instruction chains with different start instructions, each instruction having execution parameters, the method comprising:
(a) determining a priority value for each instruction based on a location of the instruction in each of the multiple instructions chains and the execution parameters of the other instructions;
(b) establishing an ordered list of instructions with a set of instructions having a highest priority value; and
(c) expanding the ordered list with instructions related to the constituent instructions of the ordered list based on the priority values.

13. The method according to claim 12 wherein step (b) includes:
identifying instructions with the highest priority value to form the set of instructions; and
nserting each instruction in the set of instructions into the ordered list.

14. The method according to claim 12 wherein the set of instructions includes the start instructions.

15. The method according to claim 12 wherein step (c) includes:
determining all instructions depending from instructions in the ordered list; and
inserting instructions depending from instructions in the ordered list having a given priority value into the ordered list.

16. A computer-readable medium having computer-executable instructions for forming an ordered list to order instructions in a swing modulo scheduling method comprising the steps of ordering instructions and scheduling the ordered instructions, wherein the instructions form multiple instruction chains with different start instructions, each instruction having execution parameters, said computer-executable instructions comprising:
(a) determining a priority value for each instruction based on a location of the instruction in each of the multiple instructions chains and the execution parameters of the other instructions;
(b) establishing an ordered list of instructions with a set of instructions having a highest priority value; and
(c) expanding the ordered list with instructions related to the constituent instructions of the ordered list based on the priority values.

17. The computer-executable instructions according to claim 16 wherein step (b) includes:
identifying instructions with the highest priority value to form the set of instructions; and
inserting each instruction in the set of instructions into the ordered list.

18. The computer-executable instructions according to claim 16 wherein the set of instructions includes the start instructions.

19. The computer-executable instructions according to claim 16 wherein step (c) includes:
determining all instructions depending from instructions in the ordered list; and
inserting instructions depending from instructions in the ordered list having a given priority value into the ordered list.
